(19) United States
(12) Patent Application Publication
(10) Pub. No.: US 2021/0232528 A1
(43) Pub. Date: Jul. 29, 2021

(54) CONFIGURABLE DEVICE INTERFACE

(71) Applicant: Intel Corporation, Santa Clara, CA (US)

(72) Inventors: Patrick G. KUTCH, Tigard, OR (US); Andrey CHILIKIN, Limerick (IE); Jin YU, Huanggang City (CN); Cunming LIANG, Shanghai (CN); Changpeng LIU, Shanghai (CN); Ziye YANG, Shanghai (CN); Gang CAO, Shanghai (CN); Xiaodong LIU, Shanghai (CN); Zhiguo WEN, Shanghai (CN); Zhihua CHEN, Shenzhen (CN)

(21) Appl. No.: 17/208,744

(22) Filed: Mar. 22, 2021

(51) Int. Cl. G06F 13/40; G06F 9/445

(52) U.S. Cl. CPC G06F 13/4068; G06F 9/44505

(57) ABSTRACT

Examples described herein relate to an apparatus comprising: a descriptor format translator accessible to a driver. In some examples, the driver and descriptor format translator share access to transmit and receive descriptors. In some examples, based on a format of a descriptor associated with a device differing from a second format of descriptor associated with the driver, the descriptor format translator is to: perform a translation of the descriptor from the format to the second format and store the translated descriptor in the second format for access by the device. In some examples, the device is to access the translated descriptor; the device is to modify content of the translated descriptor to identify at least one work request; and the descriptor format translator is to translate the modified translated descriptor into the format and store the translated modified translated descriptor for access by the driver.

FIG. 1 depicts an example of a known manner of packet and descriptor copying between a guest system and a network interface controller (NIC). The virtual function (VF) driver (VDEV driver) 104 allocates memory for packet buffers and descriptors for both packet receive (Rx) and transmit (Tx) activities. The descriptors contain pointers to regions of memory in which the packet buffers have been allocated. VF driver 104 programs the VF interface (e.g., VF assignable device interface (ADI) or virtual station interface (VSI)) of NIC 120 with these descriptor addresses.

When a packet is received, NIC 120 copies the packet by direct memory access (DMA) to a memory location identified in the next Rx descriptor and updates the Rx descriptor, which in turn notifies VF driver 104 that data is ready to be processed. For a packet transmission, after the VF driver 104 has a buffer with data to transmit, VF driver 104 completes a Tx descriptor, and NIC 120 identifies the descriptor as having been updated and initiates a DMA transfer from the buffer to NIC 120. NIC 120 transmits the packet and writes back to the Tx descriptor and provides a notification to the VF driver 104 that the packet has been transmitted.

There are multiple NIC vendors with a variety of capabilities and functionalities. Different NICs can support different formats of descriptors. However, developers such as firewall vendors or virtual network function (VNF) developers face challenges with changing or updated NICs from repeated updating and re-validation of products in order to address potential driver incompatibility or changes in interface technology (e.g., virtio-net, Intel® Ethernet Adaptive Virtual Function) to maintain use of the latest generation of NICs. Updates to kernel firmware or drivers can result in incompatibility with VF drivers (e.g., kernel and/or poll mode driver (PMD)) and incompatibility with a NIC. Single root I/O virtualization (SR-IOV) (described herein) allows a NIC to provide separate access to its resources to virtual machines. If a NIC vendor only guarantees that a specific SR-IOV VF driver will work with a specific physical function (PF) driver, there is no guarantee the VF driver in the virtual machine (VM) will continue to work as expected and testing and re-validation or driver modification may be needed.

Modern workloads and data center designs may impose networking overhead on the CPU cores. With faster networking (e.g., 25/50/100/200 Gb/s per link or other speeds), the CPU cores perform classifying, tracking, and steering of network traffic. A SmartNIC can be used by a CPU to offload complex Open vSwitch (OVS) or network storage related operations to FPGA or SOC of the SmartNIC. Interfaces to a device, such as virtio, can be used by virtual machine (VM), container, or in a bare metal scenario. For a description of virtio, see “Virtual I/O Device (VIRTIO) Version 1.1,” Committee Specification Draft 01/Public Review Draft 01 (20 Dec. 2018) as well as variations, revisions, earlier versions, or later versions.

Intel® scalable IOV (S-IOV) and single root I/O virtualization (SR-IOV) may provide virtual machines and containers access to a device using isolated shared physical function (PF) resources and multiple virtual functions (VFs) and corresponding drivers. For a description of SR-IOV, see Single Root I/O Virtualization and Sharing specification Revision 1.1 (2010) and variations thereof, earlier versions or updates thereto. For a description of SIOV, see Intel® Scalable I/O Virtualization Technical Specification (June 2018).

Using S-IOV to access the device, virtual machines and containers access a software emulation layer that simulates virtual devices (vdev) and vdevs may access the input output (IO) queues of the device. For S-IOV, a vdev corresponds to an Assignable Device Interfaces (ADI), which has its own memory-mapped I/O (MMIO) space and IO queues. SR-IOV PFs provide for discovery, managing and configuring as Peripheral Component Interconnect express (PCIe) devices. PCIe is described for example in Peripheral Component Interconnect (PCI) Express Base Specification 1.0 (2002), as well as earlier versions, later versions, and variations thereof. VFs allow control of the device and are derived from physical functions. With SR-IOV, a VF has its own independent configuration space, base address register (BAR) space and input output (IO) queues.

Either VF (SR-IOV) or ADI (S-IOV) may be assigned to a container in a pass-through manner (full or mediation), which provide one virtual device associated with a physical device instance (e.g., VF or ADI). SR-IOV can provide 128-256 VFs whereas S-IOV can provide thousands of ADIs. However, the number of container deployments may exceed the number of available VFs. In other words, a maximum number of virtual devices may be limited by a number of virtual interfaces provisioned by the hardware virtualization methodology and there may not be enough virtual interfaces to assign to all deployed containers. Accordingly, because of a shortage of virtual interfaces, device IO queues may not be available for all deployed containers.

For example, cloud service providers (CSPs), such as in multi-cloud or hybrid-cloud environments, deploy tens of thousands of container instances across VMs (e.g., approximately 2000 containers per VM) on single physical compute node that utilize a single network interface and a single storage device interface. If SR-IOV is used, if the number of containers or applications exceeds the maximum VF supported by SR-IOV, queues for a number of containers above 256 containers may not be provided.

FIG. 2 provides an overview of a system that uses vhost or virtual data path acceleration (vDPA). vDPA allows a connection between a VM or container and device to be established using virtio to provide a data-plane between a virtio driver executing within a VM and a SR-IOV VF and control-plane that is managed by a vDPA application. vDPA is supported for example in Data Plane Development Kit (DPDK) release 18.05 and QEMU version 3.0.0. A vDPA driver can set up a virtio data plane interface between the virtio driver and the device. vDPA provides a data path from a VM to a device whereby the VM may communicate with the device as a virtio device (e.g., virtio-blk storage device or virtio-net network device). Using vDPA, the data plane of the device utilizes a virtio ring consistent layout (e.g., virtqueue). vDPA can operate in conjunction with SR-IOV and SIOV. Live migration of a container and VM accessing a device using vDPA can be supported. Live migration can include changing one or more compute or memory resources that perform a container or VM to transfer memory, storage, and network or fabric connectivity to a destination.

### BRIEF DESCRIPTION OF THE DRAWINGS

FIG. 1 depicts an example of a known manner of packet and descriptor copying between a guest system and a network interface controller (NIC).

FIG. 2 provides an overview of a system that uses vhost or virtual data path acceleration (vDPA).

FIG. 3 shows an example where a driver communicates with a descriptor translator.

FIG. 4A depicts an example of transmit descriptor translation.

FIG. 4B depicts an example of receive descriptor translation.

FIG. 5 shows an example of use of descriptor translation with multiple devices.

FIG. 6 depicts an example of use of multiple guest virtual environments utilizing descriptor translation with multiple devices.

FIGS. 7A-7C depict processes for configuring and using descriptor format translation.

FIG. 8 provides an overview of various embodiments that may provide queues for containers.

FIG. 9 depicts an example process for allocating queues of a device to a virtualized execution environment.

FIG. 10 depicts an example of queue access via a vhost target.

FIG. 11 depicts an example of a request, data access, and response sequence.

FIG. 12 shows an example configuration of a virtio queue that provides per-queue configuration.

FIG. 13 depicts a system.

FIG. 14 depicts an example environment.

### DETAILED DESCRIPTION

### Translation of Descriptors

Various embodiments provide for compatibility between virtual interfaces with a variety of NICs. In some examples, NICs can be accessed as virtual devices using SR-IOV, Intel® SIOV, or other device virtualization or sharing technologies. At least to provide compatibility between virtual interfaces with a variety of NICs, various embodiments provide for descriptor format conversion in connection with packet transmission or receipt so that a virtualized execution environment (VEE) can utilize a driver for a NIC other than a NIC used to transmit or receive packets. Various embodiments provide a descriptor format converter (e.g., hardware and/or software) to identify availability of descriptors to or from a NIC for packet transmission or packet receipt, translate descriptors into another interface format, and then write the translated descriptors into a descriptor format that the VEE driver or PMD can read and act upon. For example, a developer or customer can develop an application or other software to utilize a particular NIC and utilize a particular virtual interface (e.g., virtio-net, vmxnet3, iavf, e1000, AF_XDP, ixgbevf, i40evf, and so forth) and maintain use of such interface despite a change to a different NIC that supports a different descriptor format.

For example, an application or VEE can utilize (e.g., next generation firewall (NGFW) or load balancer) could use a virtualized interface (e.g., virtio-net or vmxnet3), utilize SR-IOV with vSwitch bypass whereby the NIC copies by direct memory access (DMA) data directly to and from buffers configured by the virtual firewall, and exposes descriptors to a descriptor format converter to provide compatibility between the virtualized interface and the NIC. Various embodiments can facilitate scale out of use of resources (e.g., computing resources, memory resources, accelerator resources) via a NIC or fabric interface.

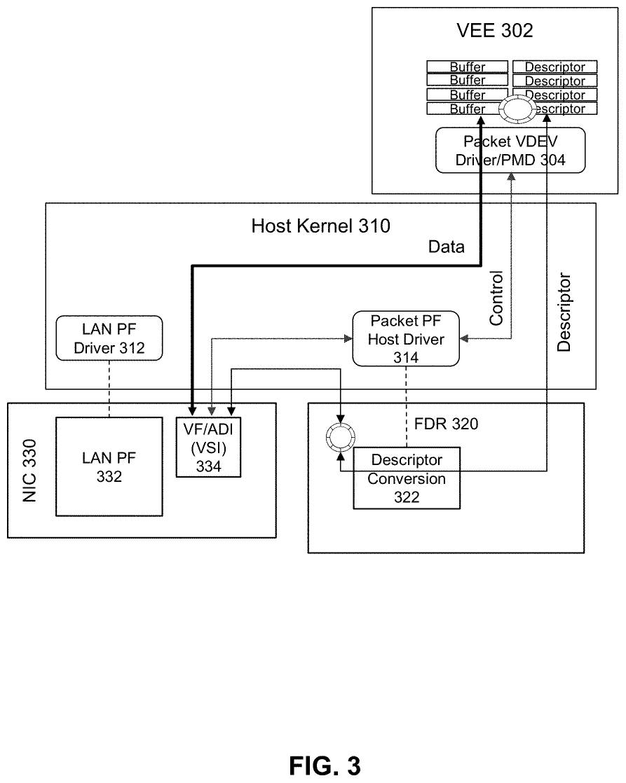

FIG. 3 depicts an example system. A guest VEE 302 can include any type of applications, service, microservice, cloud native microservice, workload, or software. For example VEE 302 can perform a virtual network function (VNF), NEXGEN firewall, virtual private network (VPN), load balancing, perform packet processing based on one or more of Data Plane Development Kit (DPDK), Storage Performance Development Kit (SPDK), OpenDataPlane, Network Function Virtualization (NFV), software-defined networking (SDN), Evolved Packet Core (EPC), or 5G network slicing. Some example implementations of NFV are described in European Telecommunications Standards Institute (ETSI) specifications or Open Source NFV Management and Orchestration (MANO) from ETSI's Open Source Mano (OSM) group.

A VNF can include a service chain or sequence of virtualized tasks executed on generic configurable hardware such as firewalls, domain name system (DNS), caching or network address translation (NAT) and can run in VEEs. VNFs can be linked together as a service chain. In some examples, EPC is a 3GPP-specified core architecture at least for Long Term Evolution (LTE) access. 5G network slicing can provide for multiplexing of virtualized and independent logical networks on the same physical network infrastructure.

Microservices can be independently deployed using centralized management of services. The management system may be written in different programming languages and use different data storage technologies. A microservice can be characterized by one or more of: use of fine-grained interfaces (to independently deployable services), polyglot programming (e.g., code written in multiple languages to capture additional functionality and efficiency not available in a single language), or lightweight container or virtual machine deployment, and decentralized continuous microservice delivery. In some examples, a microservice can communicate with one or more other microservices using protocols (e.g., application program interface (API), a Hypertext Transfer Protocol (HTTP) resource API, message service, remote procedure calls (RPC), or Google RPC (gRPC)).

A VEE can include at least a virtual machine or a container. VEEs can execute in bare metal (e.g., single tenant) or hosted (e.g., multiple tenants) environments. A virtual machine (VM) can be software that runs an operating system and one or more applications. A VM can be defined by specification, configuration files, virtual disk file, non-volatile random access memory (NVRAM) setting file, and the log file and is backed by the physical resources of a host computing platform. A VM can be an OS or application environment that is installed on software, which imitates dedicated hardware. The end user has the same experience on a virtual machine as they would have on dedicated hardware. Specialized software, called a hypervisor, emulates the PC client or server's CPU, memory, hard disk, network and other hardware resources completely, enabling virtual machines to share the resources. The hypervisor can emulate multiple virtual hardware platforms that are isolated from each other, allowing virtual machines to run Linux®, FreeBSD, VMWare, or Windows® Server operating systems on the same underlying physical host.

A container can be a software package of applications, configurations and dependencies so the applications run reliably on one computing environment to another. Containers can share an operating system installed on the server platform and run as isolated processes. A container can be a software package that contains everything the software needs to run such as system tools, libraries, and settings. Containers are not installed like traditional software programs, which allows them to be isolated from the other software and the operating system itself. Isolation can include permitted access of a region of addressable memory or storage by a particular container but not another container. The isolated nature of containers provides several benefits. First, the software in a container will run the same in different environments. For example, a container that includes PHP and MySQL can run identically on both a Linux computer and a Windows® machine. Second, containers provide added security since the software will not affect the host operating system. While an installed application may alter system settings and modify resources, such as the Windows® registry, a container can only modify settings within the container.

A physical PCIe connected NIC 330 (e.g., a SR-IOV VF, S-IOV VDEV, or a PF) can be selected as a device that will receive and transmit packets or perform work at the request of VEE 302. Various embodiments can utilize Compute Express Link (CXL) (e.g., Compute Express Link Specification revision 2.0, version 0.7 (2019), as well as earlier versions, later versions, and variations thereof) to provide communication between a host and NIC 330 or Flexible Descriptor Representor (FDR) 320. Virtual device (VDEV) driver 304 can send a configuration command to FDR 320 to connect the FDR 320 to a virtualized interface exposed by VEE 302. Note that while reference is made to a NIC, in addition or alternatively, NIC 330 can include a storage controller, storage device, an infrastructure processing unit (IPU), data processing unit (DPU), accelerators (e.g., FPGAs), or hardware queue manager (HQM).

VDEV driver 304 for VEE 302 can allocate kernel memory for descriptors and system memory for packet buffers and program FDR 320 to access those descriptors. For example, VDEV driver 304 can indicate descriptor buffer locations (e.g., Tx or Rx) to FDR 320. VDEV driver 304 can communicate with FDR 320 instead of NIC 330 to provide descriptors for packet transmit (Tx) or access descriptors for packet receive (Rx). VDEV driver 304 can allocate memory for packet buffers and Rx or Tx descriptors rings, and descriptor rings (queues) can be accessible to FDR 320 and some descriptor rings can be accessible to NIC 330.

VEE 302 can utilize a same virtualized interface (e.g., VDEV driver 304) no matter what the physical VF or SIOV NIC 330 is used for packet transmission or receipt. Examples of a virtualized interface include, but are not limited to, virtio-net, vmxnet3, iavf, e1000, AF_XDP, ixgbevf, i40evf, and so forth. In some examples, the virtualized interface used by VEE 302 can work in conjunction with Open vSwitch or Data Plane Development Kit (DPDK). Accordingly, despite use of a different NIC than NIC 330, such as from a different vendor or different model, a virtualized interface and software ecosystem can continue to be used. For example, in a scenario where VEE 302 is migrated for execution on another CPU socket, FDR 320 can perform descriptor format conversion so that VEE 302 can utilize the same virtual interface to communicate with a NIC used by another core.

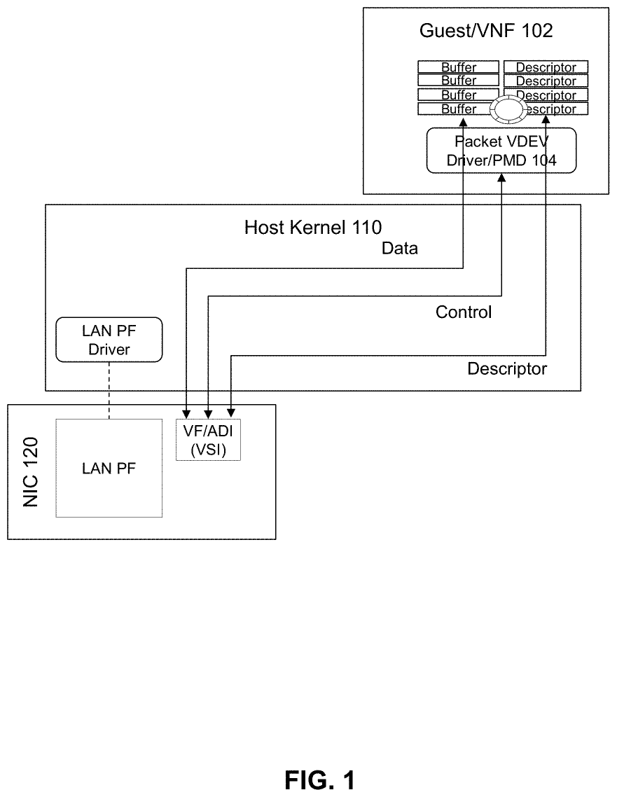

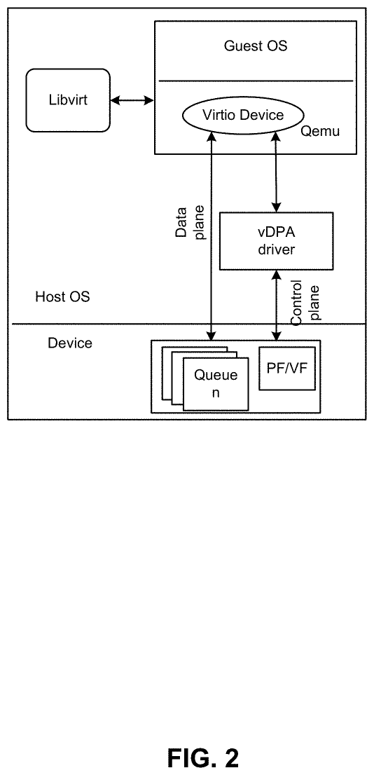

In the system of FIG. 3, VDEV driver 304 communicates with FDR 320, which interacts with VDEV driver 304 as a NIC (or other device). For example, NIC 330 of FIG. 3 can interact with VDEV driver 304 as though it were NIC 120 of FIG. 1. In the system of FIG. 1, VDEV driver 104 communicates directly with NIC 120 to configure access to queues and descriptor rings. In some examples, VDEV driver 304 can also communicate with NIC 330 to configure access to queues and descriptor rings. For example, in FIG. 1, NIC type A can be used whereas in FIG. 3, NIC type B can be used, where NIC type A and NIC type B use different formats of Rx or Tx descriptors but FDR 320 provides descriptor format conversion so that VDEV driver 304 provides and processes descriptors for NIC type A and NIC 330 processes descriptors of NIC type B.

In some examples, FDR 320 could expose multitudes of receive virtual interfaces to VEEs running on one or more servers. Virtual interfaces can be of different types, for example, some could be virtio-net consistent interfaces, some could be iafv consistent interfaces, others may be i40evf consistent interfaces. For example, a VEE could utilize NIC A from Vendor A presented as a SR-IOV VF of a NIC B from Vendor B (or another NIC from Vendor A). VEE 302 may not have access to all of the functions and capabilities of NIC A but would be able to use a VEE programmed to access a VF of NIC B. VEEs can communicate with a virtual switch (vSwitch), which allows communication between VEEs.

In some examples, PF host driver 314 can initialize FDR 320 and connect FDR 320 to NIC 330. In some examples, FDR 320 can allocate Rx/Tx descriptor rings for NIC 330. After initialization, FDR 320 can contain two copies of Rx/Tx rings, such as a Rx/Tx ring for NIC 330 and a Rx/Tx ring for VDEV driver 304. FDR 320 can utilize descriptor conversion 322 to perform descriptor translation or Rx or Tx descriptors so that a descriptor in the Rx/Tx ring for NIC 330 is a translation of a corresponding Rx or Tx descriptor in the Rx/Tx ring for VDEV driver 304. In some examples, FDR 320 can access NIC 330 as a VF or PF using SR-IOV or SIOV or NIC 330 can access FDR 320 as a VF or PF using SR-IOV or SIOV.

For example, FDR 320 can be implemented as a discrete PCIe device such as a riser card connected to a circuit board and accessible to a CPU or XPU. For example, FDR 320 can be accessible as a virtual device using a virtual interface. In some examples, FDR 320 can be implemented as a process executed in a VEE, a plugin in user space, or other software.

For example, for packet receipt, NIC 330 can copy by direct memory access (DMA) data to destination location and provide an Rx descriptor to a descriptor ring managed by FDR 320. For example, an Rx descriptor can include one or more of: packet buffer address in memory (e.g., physical or virtual), header buffer address in memory (e.g., physical or virtual), status, length, VLAN tag, errors, fragment checksum, filter identifier, and so forth. NIC 330 can update the Rx descriptor to identify a destination location of data in a buffer, for example. NIC 330 can update the Rx descriptor to indicate that it has written data to the buffer and can perform other actions such as removal of a virtual local area network (VLAN) tag from the received packet. FDR 320 can determine when NIC 330 updates an Rx descriptor or adds an Rx descriptor to a ring managed by FDR 320 (e.g., by polling or via interrupt by NIC 330). Where configured to translate a descriptor, FDR 320 can translate the Rx descriptor to a format recognized and properly readable by VDEV driver 304. Although if no descriptor translation is needed, FDR 320 can allow the Rx descriptor to be available without translation. FDR 320 can provide the translated Rx descriptor to a descriptor ring accessible to VDEV driver 304. VDEV driver 304 can determine that an Rx descriptor is available to process by VEE 302. VEE 302 can identify the received data in the destination buffer from the translated Rx descriptor.

For example, for packet transmit, VDEV driver 304 can place a packet into a memory buffer and writes to a Tx descriptor. For example, a transmit descriptor can include one or more of: packet buffer address (e.g., physical or virtual), layer 2 tag, VLAN tag, buffer size, offset, command, descriptor type, and so forth. Other examples of descriptor fields and formats are described at least in Intel® Ethernet Adaptive Virtual Function Specification (2018). VDEV driver 304 indicates to FDR 320 that a Tx descriptor is available for access. Where configured to translate a descriptor, FDR 320 can translate the Tx descriptor to a format recognized and properly readable by NIC 330. Although if no descriptor translation is needed, FDR 320 can allow the Tx descriptor to be available without translation. FDR 320 can monitor the Tx descriptors provided by VDEV driver 304, translate a recently written Tx descriptor into a descriptor format used by NIC 330, include in the translated Tx descriptor address of the data buffer to be transmitted, and write the translated descriptor into a ring that NIC 330 is monitoring. NIC 330 can read the Tx descriptor from a descriptor ring managed by FDR 320 and NIC 330 can access packet data from a memory buffer identified in the translated (or untranslated) Tx descriptor by a DMA copy operation.

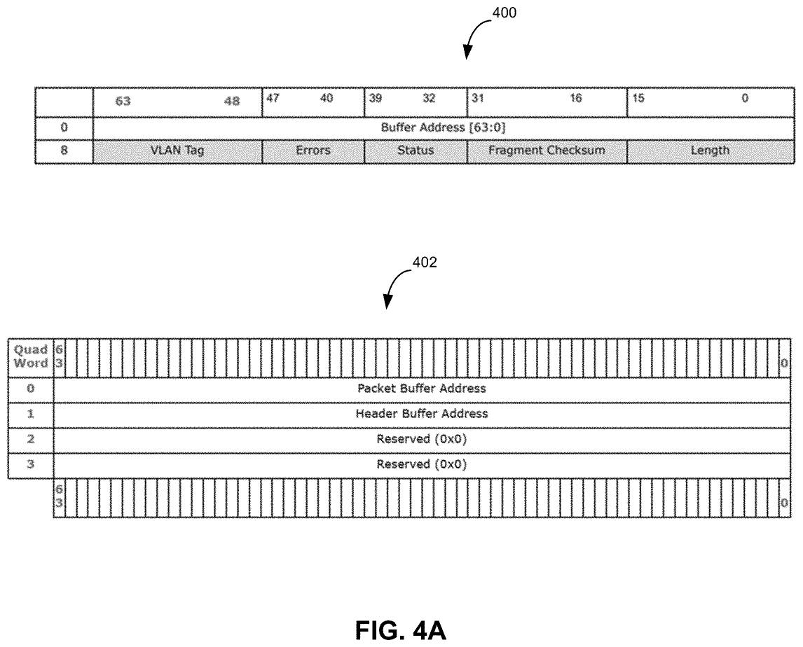

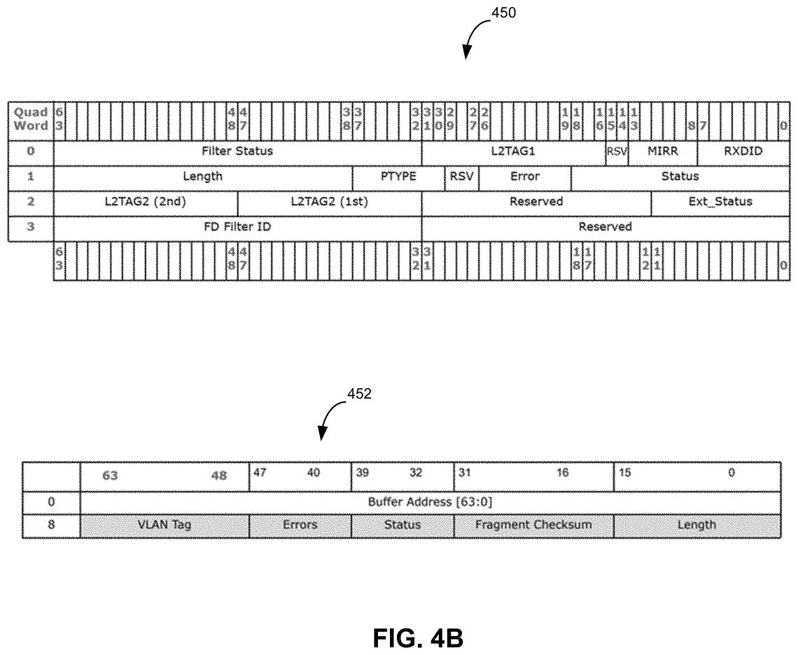

FIGS. 4A and 4B depict an example of descriptor format translations for receive descriptors but translation can apply to transmit descriptors. Descriptor translation can include copying all or a subset of a field of a descriptor to a field in a descriptor of another format. Descriptor translation can include inserting values into one or more fields of a descriptor of another format even if the values are not present in a descriptor that is being translated. Various examples relate to VDEV driver providing an empty descriptor to an FDR or descriptor translator and FDR or descriptor translator providing a descriptor for a received packet to VDEV driver.

As shown in FIG. 4A, a VDEV driver provides descriptor 400 to FDR or descriptor translator. This Rx descriptor is a legacy Intel® 82599 NIC format. A VDEV driver may provide a buffer address value in the bits [63:0]. Fields VLAN Tag, Errors, Status, Fragment Checksum and Length are initialized to zero and can be filled-in on packet receipt by the NIC.

An FDR or descriptor translator may convert the descriptor format 400 to Rx descriptor format 402 where an Intel® E800 NIC is used. An FDR or descriptor translator may copy buffer address bits to the corresponding bits of descriptor format 402, translating original legacy 16 byte descriptor to a 32 byte descriptor.

As shown in FIG. 4B, the NIC provides an Rx descriptor corresponding to a received packet back to the VDEV driver. The NIC receives a packet, DMAs it to the buffer address and marks RX descriptor as complete. An FDR or descriptor translator can translate the Rx descriptor in format 450 and extract corresponding fields to insert them in descriptor format 452. Translation and mapping can be performed such as field's length in bits changed and only valid bits copied. For example, information in L2TAG1 of descriptor 450 can be translated and conveyed in VLAN Tag of descriptor 452; information in field Error of descriptor 450 can be translated and conveyed in field Errors of descriptor 452; information in Status of descriptor 450 can be translated and conveyed in Status of descriptor 452; and information in Length of descriptor 450 can be translated and its information conveyed in Length of descriptor 452. Fragment checksum is not present in the NIC descriptor, so FDR may calculate a raw checksum to provide its value to VDEV driver if needed.

Referring to FIG. 3 again, using a control path, VDEV driver 304 may configure tunnel encapsulation/decapsulation, or offload to FDR 320 or some software executing on NIC 330.

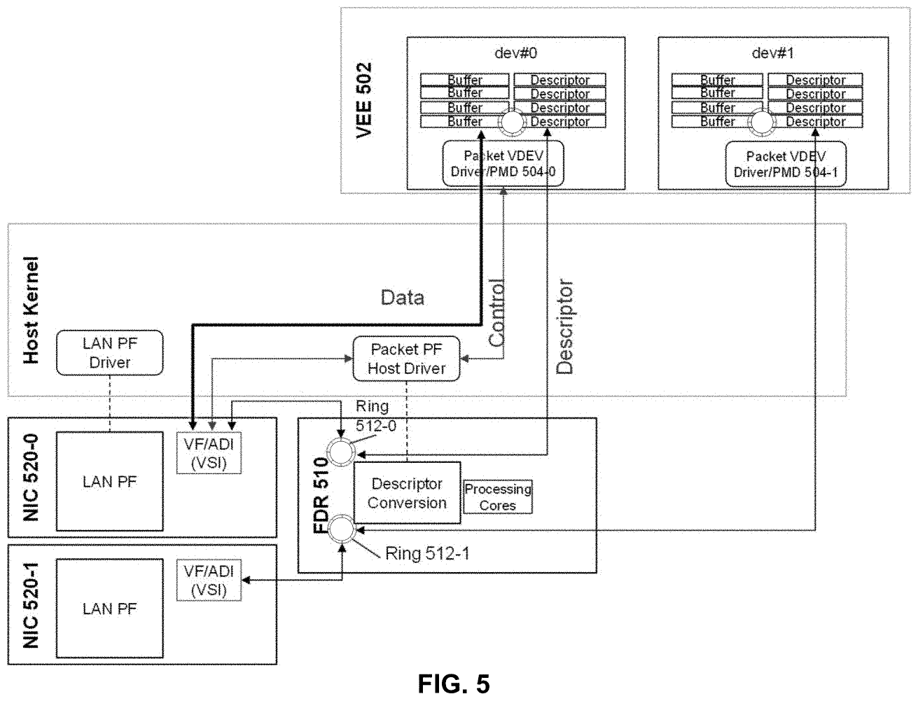

FIG. 5 shows an example of use of multiple NICs for a VEE. FDR 510 can provide descriptor ring 512-0 for NIC 520-0 and descriptor ring 512-1 for NIC 520-1. In this example, VDEV driver 504-0 for dev #0 and VDEV driver 504-1 for dev #1 executing in VEE 502 can communicate with FDR 510. FDR 510 can perform descriptor conversion of transmit and receive descriptors from a format properly readable by NICs 520-0 and 520-1 to a format properly readable by a virtual interface, respective VDEV driver 504-0 for dev #0 and VDEV driver 504-1 for dev #1 executing in VEE 502, and vice versa. In some examples, NIC 520-0 can support a same or different Tx and Rx descriptor format than that used by NIC 520-1. Although two NICs are shown, any number of NICs can be used that utilize the same or different Tx or Rx descriptor formats. Multiple instances of FDR 510 can be utilized.

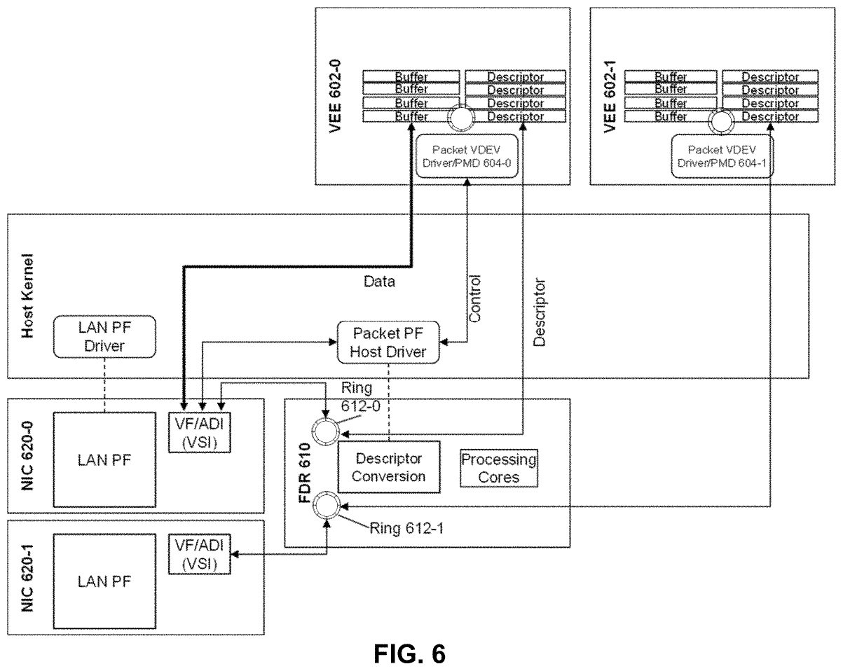

FIG. 6 depicts an example of use of multiple guest VEEs utilizing multiple NICs. FDR 610 can provide descriptor ring 612-0 for NIC 620-0 and descriptor ring 612-1 for NIC 620-1. In this example, VDEV driver 604-0 for VEE 602-0 and VDEV driver 604-1 for VEE 602-0 can communicate with FDR 610. FDR 610 can perform descriptor conversion of transmit and receive descriptors from a format properly readable by NICs 620-0 and 620-1 to a format properly readable by a virtual interface, respective VDEV driver 604-0 and VDEV driver 604-1, and vice versa. In some examples, NIC 620-0 can support a same or different Tx and Rx descriptor format than that used by NIC 620-1. Although two NICs are shown, any number of NICs can be used that utilize the same or different Tx or Rx descriptor formats. Multiple instances of FDR 610 can be utilized.

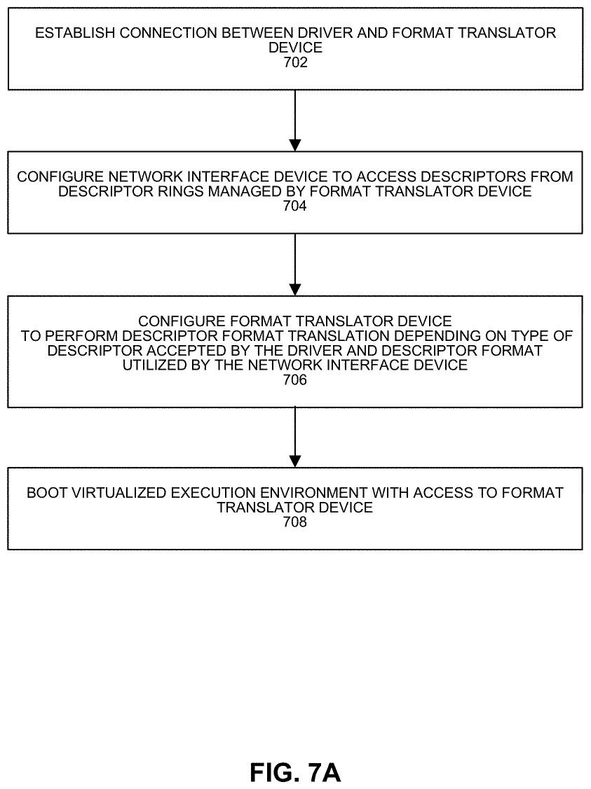

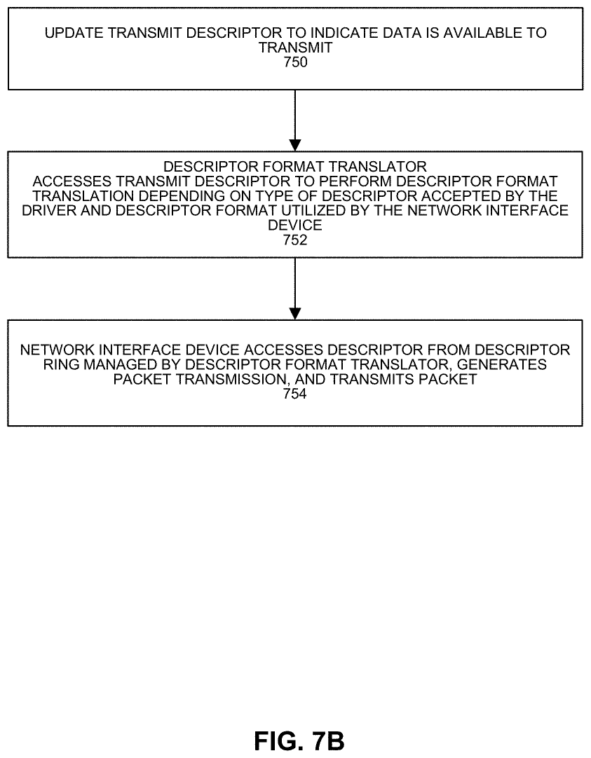

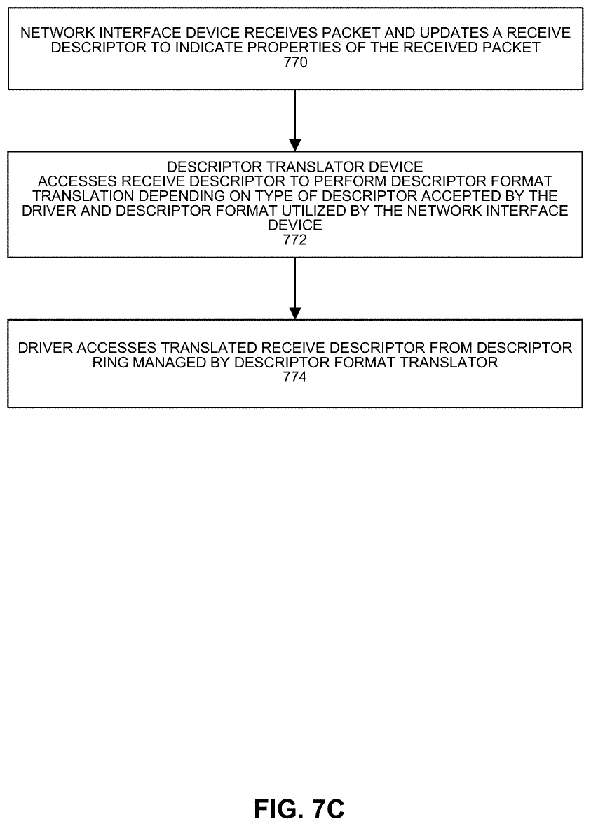

FIG. 7A depicts an example process to setup use of descriptor translation and a NIC. At 702, a connection can be formed between a descriptor format translator and a VEE. For example, the descriptor format translator can be represented as a PCIe endpoint, such as a virtual device (e.g., VF or virtio) or PF, to a VEE. For example, a virtual interface driver can setup the connection between the descriptor format translator and the VEE.

At 704, the descriptor format translator can be setup to provide access to descriptors to a NIC. For example, a PF host driver can initialize the descriptor format translator and connect it to a NIC, so the descriptor format translator can allocate Rx or Tx descriptor rings for access by the NIC and the NIC will access descriptors from rings identified by the descriptor format translator. For example, the PF host driver can program the NIC to identify transmit and receive descriptor rings in a memory region managed by the descriptor format translator and allocated for use by the NIC. In some examples, the descriptor format translator can program the virtual function ADI (e.g., VF or ADI) of the NIC to read or write descriptors using descriptors in the memory region managed by the descriptor format translator. The NIC can access descriptors from the descriptor rings managed by the descriptor format translator. The descriptor rings accessible to the NIC can be in allocated in descriptor format translator memory or in system memory. In some examples, separate rings can be allocated for transmit and receive descriptors. Other setup operations can be performed for the device such as input-output memory management unit (IOMMU) configuration that connects a DMA-capable I/O bus to main memory, interrupt setup, and so forth.

At 706, the virtual interface can setup descriptor translation to be performed by the descriptor format translator so that the descriptor format received by the NIC or read by the VEE or its virtual interface are properly read. The manner of descriptor translation can be specified to translate a source descriptor to destination descriptor at a bit-by-bit and/or field-by-field basis.

At 708, at boot of a VEE, the VEE can perform PCIe discovery and discover the descriptor format translator. The VEE can read from or write descriptors to rings managed and allocated to the descriptor format translator using a virtual device driver as though the VEE were communicating with the NIC directly.

FIG. 7B depicts an example process to use descriptor translation with a NIC for a packet transmission. At 750, in connection with a packet transmission request, a VEE updates a transmit descriptor to identify data to transmit. In other examples, for a NIC or other device, the transmit descriptor can indicate a work request. At 752, a descriptor format translator can access the transmit descriptor from a transmit descriptor ring and perform a translation of the descriptor based on its configuration. Descriptor format translation can include one or more of: copying one or more fields from a first descriptor to a second descriptor; expanding or contracting content in one or more fields in a first descriptor and writing the expanded or contracted content to one or more fields in a second descriptor; filling-in content or leaving blank one or more fields of the second descriptor where such one or more fields are not completed in the first descriptor; and so forth. In some examples, for descriptor conversion, a bit-by-bit conversion scheme can be applied. The first descriptor can be of a format generated by a virtual interface driver and the second format can be a format readable by the NIC. In some examples, no descriptor format translation is performed if the descriptor format used by the device driver is supported by the NIC. The descriptor format translator can place pointers to translated descriptors in a transmit descriptor ring for access by the NIC.

At 754, the NIC can perform a packet transmission based on access of a transmit descriptor from a descriptor ring managed by the descriptor format translator. The NIC can copy payload data from a memory buffer by a DMA operation based on buffer information in the transmit descriptor. The NIC can update the transmit descriptor to indicate that the transmit is complete. The updated transmit descriptor can be translated by the descriptor format translator to a format readable by the virtual interface driver.

FIG. 7C depicts an example process to use descriptor translation with a NIC in response to packet receipt. At 770, in connection with a packet receipt, the NIC can read the receive descriptor to identify a data storage location in memory of a portion of a payload of the received packet. The NIC can complete fields in the receive descriptor such as to indicate checksum validation or other packet metadata. The receive descriptor can be identified in a ring managed by a descriptor format translator. The NIC can copy a payload of the received packet using a DMA operation to a destination buffer location identified in the receive descriptor. In other examples, for a NIC or other device, the receive descriptor can indicate a work request.

At 772, descriptor format translator can access the receive descriptor from a receive descriptor ring and perform a translation of the descriptor based on its configuration. Format translation can include one or more of: copying one or more fields from a first descriptor to a second descriptor; expanding or contracting content in one or more fields in a first descriptor and writing the expanded or contracted content to one or more fields in a second descriptor; filling-in content or leaving blank one or more fields of the second descriptor where such one or more fields are not completed in the first descriptor; and so forth. In some examples, for descriptor conversion, a bit-by-bit conversion scheme can be applied. The first descriptor can be of a format readable and modified by the NIC and the second format can be a format readable by the virtual interface driver. The descriptor format translator can place pointers to translated descriptors in a receive descriptor ring for access by the virtual interface driver. In some examples, no descriptor format translation is performed if the descriptor format used by the NIC is properly readable by the device driver.

At 774, the virtual interface driver can access the translated receive descriptor and allow the VEE to access packet payload data referenced by the translated receive descriptor.

While examples described in FIGS. 7A-7C are with respect to a NIC or network interface device, various embodiments can apply to any workload descriptor format translation for a device such as an accelerator, hardware queue manager (HQM), queue management device (QMD), storage controller, storage device, accelerator, and so forth.

### Configurable Number of Accessible Device Queues

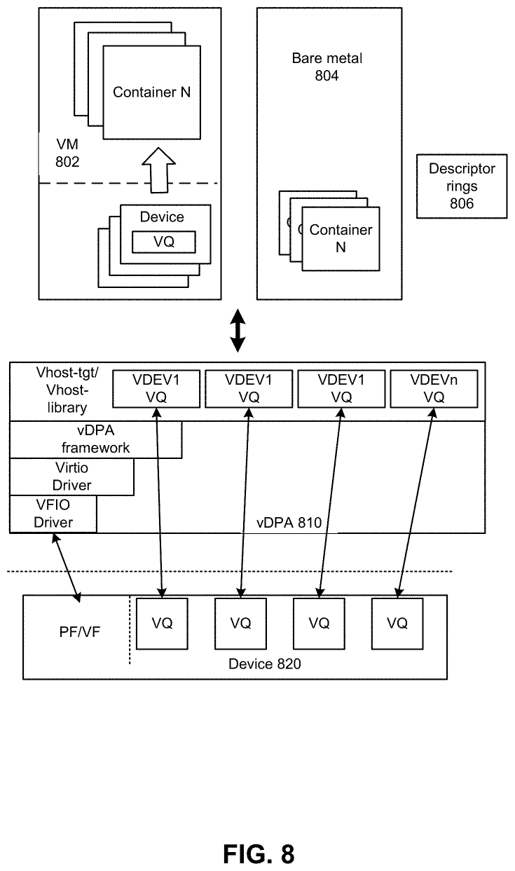

FIG. 8 provides an overview of various embodiments that may provide queues for N containers running in a VM or bare metal environment. Various embodiments configure a number of queues (VQs) in device 820 for access (e.g., read or write) by VEEs by configuring a number of virtual devices configured as active in vDPA application 810. Other frameworks can be used such as virtio. In some examples, vDPA application 810 runs in user space, but may run in kernel space. vDPA application 810 can be based on a vDPA framework developed using DPDK or QEMU in some examples. In some examples, an active virtual device in vDPA application 810 can be a vhost target. To provide 1:1 mapping of queues to VEEs, a number of vhost targets (e.g., vhost-tgt) can be determined by an input parameter but may not exceed the number of virtio queues or queues available in device 820.

A virtual device (e.g., vhost target) in vDPA application 810 can provide the control plane and data plane for a VEE (e.g., VM 802 and its containers or containers running in bare metal environment 804). An IO queue (VQ) in device 820 (e.g., storage controller or network interface) can be accessed one-to-one by a corresponding virtual device. IO queues in device 820 allocated for a VF (SR-IOV) or ADI (SIOV) may be increased or decreased and assigned to deployed VEEs by increasing or decreasing a number of active virtual devices in vDPA application 810. A VF or ADI can provide connectivity between a virtual device in vDPA application 810 and device 820 for tenant isolation. A single isolated instance (e.g., VF or ADI) can be associated with a VEE. In this way, sharing of device 820 with isolation of IO queues can be achieved. Virtual devices could either have a dedicated physical queue pair or share a physical queue pair with other virtual devices.

An interface between a VEE and vDPA application 810 can be implemented through a vhost library as a vhost target. A virtio driver executing in a VEE can connect to the vhost target and device 820 through vDPA framework or application 810. vDPA framework or application 810 can connect the vhost target to device 820. When device 820 supports SR-IOV, access through a PF or VF can be utilized. vDPA application 810 can interact with a PF or VF as a device. In some examples, connecting a VEE to a SmartNIC using SIOV can provide access to features of a virtio queue, including rate limiting and queue scheduling, etc. Data plane pass-through between device 820 to a VEE can be used to reduce delays in data or descriptor transfer.

In some examples, virtual devices communicate with VEEs using a virtio driver. Descriptors can be passed from a VEE to a virtual device using a virtio ring and provided to a corresponding IO queue of device 820. In some examples, virtual devices configured in vDPA application 810 can access descriptor virtio rings. The virtio data plane can be mapped from a VEE to the VF of device 820.

An example pseudocode of vDPA application 810 that has a configured number of vhost targets is below.

| | |
|---|---|
| cmd: | vdpa -10,2 −socket-mem 1024 -w 0000:00:02.0, vdpa=1, mapping=128 -- --iface /tmp/vdpa |

// mapping=128 means start 128 vhost targets.
vDPA process:
vdpa_app.c:
start_vdpa ( ) :

vhost_driver_register( );
vhost_driver_attach_vdpa_device( );
vhost_driver_start( )

ifc.c:
pci_dev_probe( ): input mapping

| pci_dev->num_queueus = get_pci_capability( ); | |
|---|---|
| vdpa->mappings = (pci_dev->num_queues > mapping) ? mapping : | |
| pci_dev->num_queues; | |
| for (i = 0; i < vdpa->mapping; i++) { | |
| | vdpa_register_device(vdpa, ops); |

}

ops {

open = vdpa_config,

};
vdpa_config( ):

updata_datapath( );

updata_datapath( ):

dma_map( );
enable_intr( );
vdpa_start( );

vdpa_start( ):

set_vring_base( );
start_hw( );

Various embodiments using vDPA application 810 can provide flexibility to scale a number of VEEs and corresponding queues in device 820. Various embodiments allow use of a commonly used interface such as a virtio driver for a VEE to access vDPA application 810. In some cases, driver modification may not be needed to be made to a VEE or software running in the VEE to support one-to-one VEE-to-device queue access.

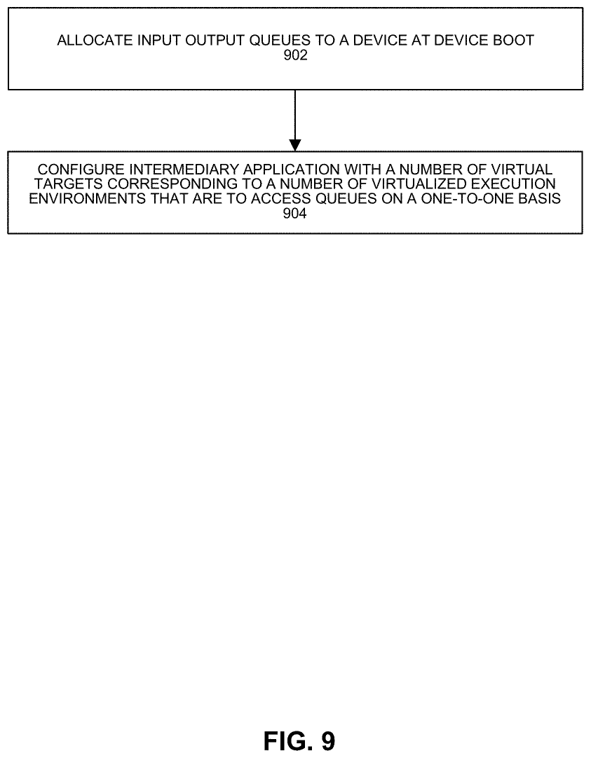

FIG. 9 depicts an example process for allocating queues of a device to a virtualized execution environment. At 902, at device boot, a number of input output (IO) queues can be allocated in the device. For example, a maximum permitted number of IO queues can be allocated in the device. In some examples, the device includes a storage controller, storage device, network interface card, hardware queue manager (HQM), accelerator, among others.

At 904, in an intermediary application, a number of virtual targets can be allocated where the number of virtual targets correspond to a number of IO queues that are to be allocated one-to-one to VEEs. For example, the intermediary application can be a vDPA application developed using DPDK or QEMU. For example, a number of IO queues, among the allocated IO queues at the device, can be set by adding or deleting vhost targets in a vDPA application. A number of IO queues can be scaled up or down according to the number of vhost targets in the vDPA application. A number of vhost targets and corresponding IO queues can be specified when a vDPA application is started, or through remote procedure call (RPC) command.

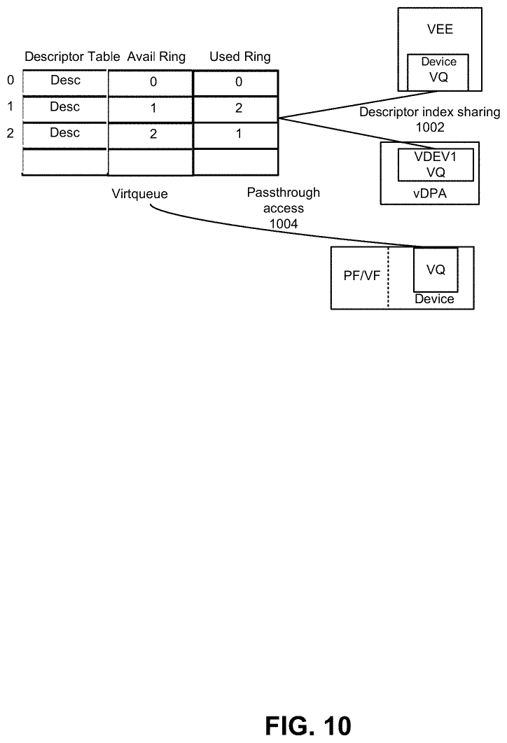

FIG. 10 depicts an example of queue access by a VEE via a vhost target. In some examples, input output (IO) processing between VEE and vhost target can be realized through virtio queues (virtqueue). In some examples, a virtio queue can be used to transfer an available (avail) ring index corresponding to a descriptor in a descriptor table and/or used ring entry index corresponding to a descriptor in a descriptor table. In some examples, a VEE and vhost target share read and write access to a virtqueue, and a vDPA application provides passthrough of entries in the virtqueue to the virtual queue (VQ) of the device. The vDPA application can provide communication between the virtio driver of the VEE and between the vhost target and IO queue(s).

In some examples, to send an IO request (e.g., read or write) to the device, a VEE can locate a free (available) descriptor entry from the descriptor table stored in memory in the host and shared, at 1002, by the VEE with vDPA application (shown as vDPA). In this example, a free entry is a desc with index 0 (desc 0). The VEE fills an IO request into desc 0, fills the available (avail) ring tail entry value 0, and notifies a vhost target by sending a notification event via a virtio driver. The descriptor can identify an IO request, including request(req), data and response(rsp). A descriptor can specify a command (e.g., read or write), an address of data to access in memory, a length of data to access, and other information such as sector or response status. A descriptor can point to an address in memory accessible by the device using a direct memory access (DMA) operation. At 1004, the device can access the descriptor via a virtqueue. The VEE can wait for feedback from the vhost target and check the used ring to see which IO request is completed, and set the completed descriptor to idle.

A particular vhost target can be triggered by a notification sent by a VEE's driver to check the available (avail) ring to determine which descriptor (desc) includes the IO request from the VEE. The vhost target can process the descriptor in the available (avail) ring. After the IO operation specified by the descriptor is completed, the vhost target may update the used ring to indicate the completion in a response status and notify the VEE by sending notification event.

In some examples, if the device is a storage controller or storage device (e.g., with one or more non-volatile memory devices), for access to a storage device, a single virtqueue can be used to send requests and receive responses. The VEE can use a virtqueue to provide an avail ring index to pass a descriptor to the vhost target and the vhost target can update the virtqueue with a used ring index to the VEE. Writing to storage can be a write command, and reading from storage can be a read command. For a write or read command, a free entry in the descriptor table can be identified and filled with the command, indicating that write or read, where the data should be written to or read from. The descriptor can be identified at a tail entry of the avail ring via a virtqueue and then the vhost target notified of an available descriptor. After the vhost target completes the IO operation, it can write the result of the processing on the status, then update the used ring, and write the index value of the descriptor in the tail entry of the used ring then notify the VEE. VEE can read the used ring via the virtqueue and obtain the descriptor to determine that the IO request is completed successfully or not and data is in the memory pointed to by the data pointer. In some examples, descriptor format conversion can be used to modify descriptors using embodiments described herein.

In some examples, if the device is a network device, two virtqueues can be used, such as a receive virtqueue and a transmit virtqueue. A transmit virtqueue can be used by a VEE to transmit requests to a vhost target. A receive virtqueue can be used by a VEE to accept requests from a vhost target. Different virtqueues can provide independent communication.

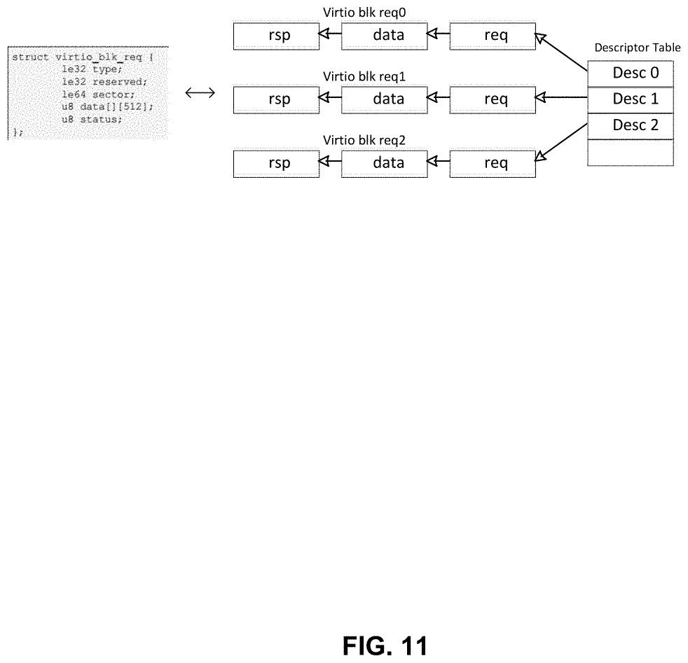

FIG. 11 depicts an example of a virtio block request (req), data access, and response (rsp) format sequence. The code segment struct virtio_blk_req can represent a format of a virtio block request.

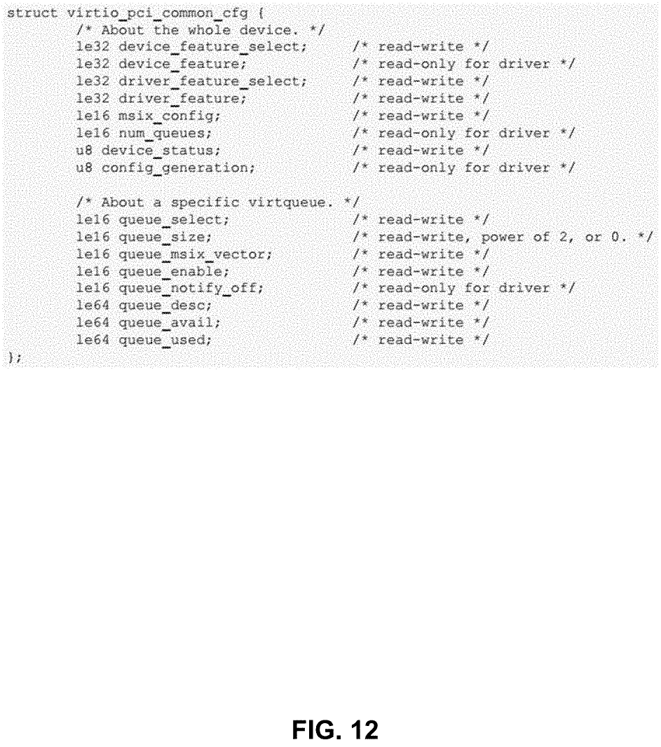

FIG. 12 shows an example pseudocode of a configuration of a virtio queue that provides per-queue configuration, including configuration of msix_vector, enable and notify_off. Accordingly, a queue can be individually configured and enabled.

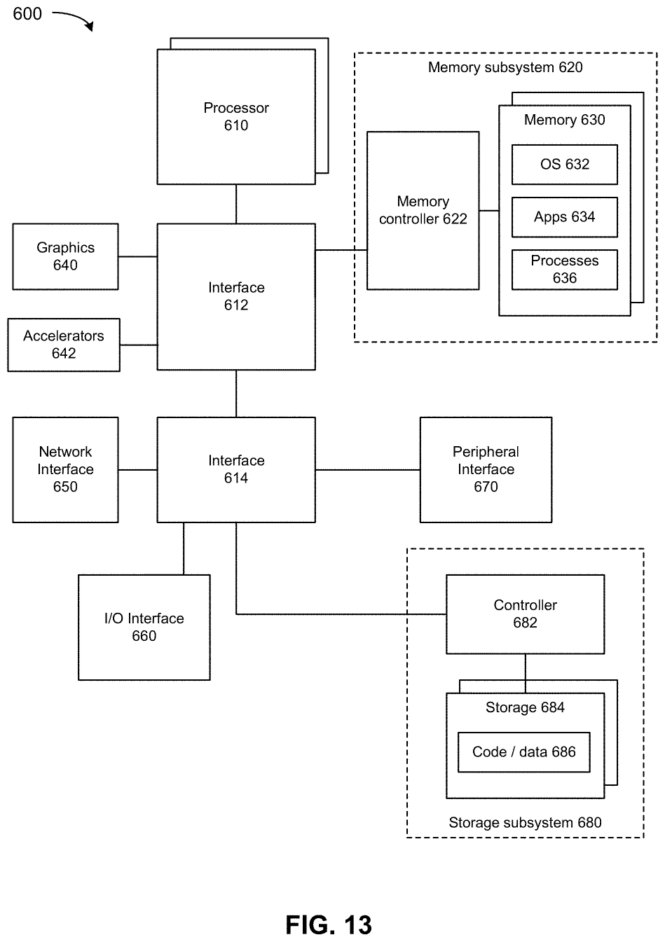

FIG. 13 depicts an example system. Any of the devices herein (e.g., accelerator, network interface, storage device, and so forth) can utilize descriptor format conversion described herein. System 1300 includes processor 1310, which provides processing, operation management, and execution of instructions for system 1300. Processor 1310 can include any type of microprocessor, central processing unit (CPU), graphics processing unit (GPU), processing core, or other processing hardware to provide processing for system 1300, or a combination of processors. Processor 1310 controls the overall operation of system 1300, and can be or include, one or more programmable general-purpose or special-purpose microprocessors, digital signal processors (DSPs), programmable controllers, application specific integrated circuits (ASICs), programmable logic devices (PLDs), or the like, or a combination of such devices.

In one example, system 1300 includes interface 1312 coupled to processor 1310, which can represent a higher speed interface or a high throughput interface for system components that needs higher bandwidth connections, such as memory subsystem 1320 or graphics interface components 1340, or accelerators 1342. Interface 1312 represents an interface circuit, which can be a standalone component or integrated onto a processor die. Where present, graphics interface 1340 interfaces to graphics components for providing a visual display to a user of system 1300. In one example, graphics interface 1340 can drive a high definition (HD) display that provides an output to a user. High definition can refer to a display having a pixel density of approximately 100 PPI (pixels per inch) or greater and can include formats such as full HD (e.g., 1080p), retina displays, 4K (ultra-high definition or UHD), or others. In one example, the display can include a touchscreen display. In one example, graphics interface 1340 generates a display based on data stored in memory 1330 or based on operations executed by processor 1310 or both. In one example, graphics interface 1340 generates a display based on data stored in memory 1330 or based on operations executed by processor 1310 or both.

Accelerators 1342 can be a programmable or fixed function offload engine that can be accessed or used by a processor 1310. For example, an accelerator among accelerators 1342 can provide compression (DC) capability, cryptography services such as public key encryption (PKE), cipher, hash/authentication capabilities, decryption, or other capabilities or services. In some embodiments, in addition or alternatively, an accelerator among accelerators 1342 provides field select controller capabilities as described herein. In some cases, accelerators 1342 can be integrated into a CPU socket (e.g., a connector to a motherboard or circuit board that includes a CPU and provides an electrical interface with the CPU). For example, accelerators 1342 can include a single or multi-core processor, graphics processing unit, logical execution unit single or multi-level cache, functional units usable to independently execute programs or threads, application specific integrated circuits (ASICs), neural network processors (NNPs), programmable control logic, and programmable processing elements such as field programmable gate arrays (FPGAs). Accelerators 1342 can provide multiple neural networks, CPUs, processor cores, general purpose graphics processing units, or graphics processing units can be made available for use by artificial intelligence (AI) or machine learning (ML) models. For example, the AI model can use or include any or a combination of: a reinforcement learning scheme, Q-learning scheme, deep-Q learning, or Asynchronous Advantage Actor-Critic (A3C), combinatorial neural network, recurrent combinatorial neural network, or other AI or ML model. Multiple neural networks, processor cores, or graphics processing units can be made available for use by AI or ML models.

Memory subsystem 1320 represents the main memory of system 1300 and provides storage for code to be executed by processor 1310, or data values to be used in executing a routine. Memory subsystem 1320 can include one or more memory devices 1330 such as read-only memory (ROM), flash memory, one or more varieties of random access memory (RAM) such as DRAM, or other memory devices, or a combination of such devices. Memory 1330 stores and hosts, among other things, operating system (OS) 1332 to provide a software platform for execution of instructions in system 1300. Additionally, applications 1334 can execute on the software platform of OS 1332 from memory 1330. Applications 1334 represent programs that have their own operational logic to perform execution of one or more functions. Processes 1336 represent agents or routines that provide auxiliary functions to OS 1332 or one or more applications 1334 or a combination. OS 1332, applications 1334, and processes 1336 provide software logic to provide functions for system 1300. In one example, memory subsystem 1320 includes memory controller 1322, which is a memory controller to generate and issue commands to memory 1330. It will be understood that memory controller 1322 could be a physical part of processor 1310 or a physical part of interface 1312. For example, memory controller 1322 can be an integrated memory controller, integrated onto a circuit with processor 1310.

While not specifically illustrated, it will be understood that system 1300 can include one or more buses or bus systems between devices, such as a memory bus, a graphics bus, interface buses, or others. Buses or other signal lines can communicatively or electrically couple components together, or both communicatively and electrically couple the components. Buses can include physical communication lines, point-to-point connections, bridges, adapters, controllers, or other circuitry or a combination. Buses can include, for example, one or more of a system bus, a Peripheral Component Interconnect (PCI) bus, a Hyper Transport or industry standard architecture (ISA) bus, a small computer system interface (SCSI) bus, a universal serial bus (USB), or an Institute of Electrical and Electronics Engineers (IEEE) standard 1394 bus (Firewire).

In one example, system 1300 includes interface 1314, which can be coupled to interface 1312. In one example, interface 1314 represents an interface circuit, which can include standalone components and integrated circuitry. In one example, multiple user interface components or peripheral components, or both, couple to interface 1314. Network interface 1350 provides system 1300 the ability to communicate with remote devices (e.g., servers or other computing devices) over one or more networks. Network interface (e.g., NIC) 1350 can include an Ethernet adapter, wireless interconnection components, cellular network interconnection components, USB (universal serial bus), or other wired or wireless standards-based or proprietary interfaces. Network interface 1350 can transmit data to a device that is in the same data center or rack or a remote device, which can include sending data stored in memory. Network interface 1350 can receive data from a remote device, which can include storing received data into memory. Various embodiments can be used in connection with network interface 1350, processor 1310, and memory subsystem 1320.

Some examples of network device 1350 are part of an Infrastructure Processing Unit (IPU) or data processing unit (DPU) or utilized by an IPU or DPU. An IPU or DPU can include a network interface with one or more programmable or fixed function processors to perform offload of operations that could have been performed by a CPU. The IPU or DPU can include one or more memory devices. In some examples, the IPU or DPU can perform virtual switch operations, manage storage transactions (e.g., compression, cryptography, virtualization), and manage operations performed on other IPUs, DPUs, servers, or devices.

In some examples, queues in network interface 1350 can be increased or decreased using virtual targets configured in a vDPA application as described herein and accessible using VEEs.

In one example, system 1300 includes one or more input/output (I/O) interface(s) 1360. I/O interface 1360 can include one or more interface components through which a user interacts with system 1300 (e.g., audio, alphanumeric, tactile/touch, or other interfacing). Peripheral interface 1370 can include any hardware interface not specifically mentioned above. Peripherals refer generally to devices that connect dependently to system 1300. A dependent connection is one where system 1300 provides the software platform or hardware platform or both on which operation executes, and with which a user interacts.

In one example, system 1300 includes storage subsystem 1380 to store data in a nonvolatile manner. In one example, in certain system implementations, at least certain components of storage 1380 can overlap with components of memory subsystem 1320. Storage subsystem 1380 includes storage device(s) 1384, which can be or include any conventional medium for storing large amounts of data in a nonvolatile manner, such as one or more magnetic, solid state, or optical based disks, or a combination. Storage 1384 holds code or instructions and data 1386 in a persistent state (e.g., the value is retained despite interruption of power to system 1300). Storage 1384 can be generically considered to be a “memory,” although memory 1330 is typically the executing or operating memory to provide instructions to processor 1310. Whereas storage 1384 is nonvolatile, memory 1330 can include volatile memory (e.g., the value or state of the data is indeterminate if power is interrupted to system 1300). In one example, storage subsystem 1380 includes controller 1382 to interface with storage 1384. In one example controller 1382 is a physical part of interface 1314 or processor 1310 or can include circuits or logic in both processor 1310 and interface 1314.

A volatile memory is memory whose state (and therefore the data stored in it) is indeterminate if power is interrupted to the device. Dynamic volatile memory requires refreshing the data stored in the device to maintain state. One example of dynamic volatile memory incudes DRAM (Dynamic Random Access Memory), or some variant such as Synchronous DRAM (SDRAM). Another example of volatile memory includes cache or static random access memory (SRAM). A memory subsystem as described herein may be compatible with a number of memory technologies, such as DDR3 (Double Data Rate version 3, original release by JEDEC (Joint Electronic Device Engineering Council) on Jun. 27, 2007). DDR4 (DDR version 4, initial specification published in September 2012 by JEDEC), DDR4E (DDR version 4), LPDDR3 (Low Power DDR version3, JESD209-3B, August 2013 by JEDEC), LPDDR4) LPDDR version 4, JESD209-4, originally published by JEDEC in August 2014), WIO2 (Wide Input/output version 2, JESD229-2 originally published by JEDEC in August 2014, HBM (High Bandwidth Memory, JESD325, originally published by JEDEC in October 2013, LPDDR5 (currently in discussion by JEDEC), HBM2 (HBM version 2), currently in discussion by JEDEC, or others or combinations of memory technologies, and technologies based on derivatives or extensions of such specifications. The JEDEC standards are available at www.jedec.org.

A non-volatile memory (NVM) device is a memory whose state is determinate even if power is interrupted to the device. In some embodiments, the NVM device can comprise a block addressable memory device, such as NAND technologies, or more specifically, multi-threshold level NAND flash memory (for example, Single-Level Cell (“SLC”), Multi-Level Cell (“MLC”), Quad-Level Cell (“QLC”), Tri-Level Cell (“TLC”), or some other NAND). A NVM device can also comprise a byte-addressable write-in-place three dimensional cross point memory device, or other byte addressable write-in-place NVM device (also referred to as persistent memory), such as single or multi-level Phase Change Memory (PCM) or phase change memory with a switch (PCMS), Intel® Optane™ memory, NVM devices that use chalcogenide phase change material (for example, chalcogenide glass), resistive memory including metal oxide base, oxygen vacancy base and Conductive Bridge Random Access Memory (CB-RAM), nanowire memory, ferroelectric random access memory (FeRAM, FRAM), magneto resistive random access memory (MRAM) that incorporates memristor technology, spin transfer torque (STT)-MRAM, a spintronic magnetic junction memory based device, a magnetic tunneling junction (MTJ) based device, a DW (Domain Wall) and SOT (Spin Orbit Transfer) based device, a thyristor based memory device, or a combination of any of the above, or other memory.

A power source (not depicted) provides power to the components of system 1300. More specifically, power source typically interfaces to one or multiple power supplies in system 1300 to provide power to the components of system 1300. In one example, the power supply includes an AC to DC (alternating current to direct current) adapter to plug into a wall outlet. Such AC power can be renewable energy (e.g., solar power) power source. In one example, power source includes a DC power source, such as an external AC to DC converter. In one example, power source or power supply includes wireless charging hardware to charge via proximity to a charging field. In one example, power source can include an internal battery, alternating current supply, motion-based power supply, solar power supply, or fuel cell source.

In an example, system 1300 can be implemented using interconnected compute sleds of processors, memories, storages, network interfaces, and other components. High speed interconnects can be used such as PCIe, Ethernet, or optical interconnects (or a combination thereof).

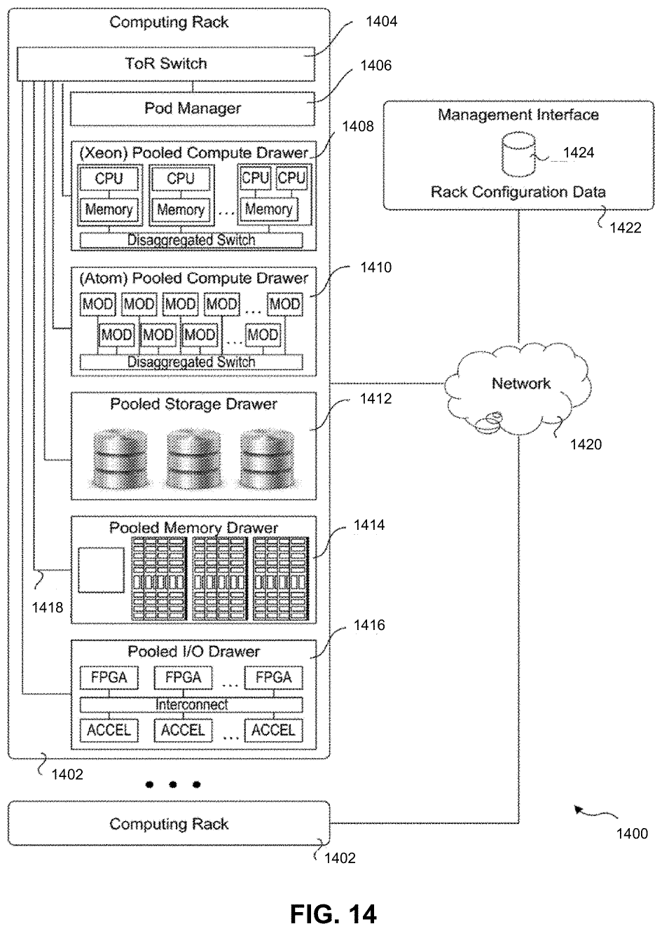

FIG. 14 depicts an environment 1400 includes multiple computing racks 1402, each including a Top of Rack (ToR) switch 1404, a pod manager 1406, and a plurality of pooled system drawers. Various devices in environment 1400 can use embodiments described herein for descriptor format conversion and/or virtual queue access using descriptor passing through virtual targets in a vDPA application. Generally, the pooled system drawers may include pooled compute drawers and pooled storage drawers. Optionally, the pooled system drawers may also include pooled memory drawers and pooled Input/Output (I/O) drawers. In the illustrated embodiment the pooled system drawers include an Intel® XEON® pooled computer drawer 1408, and Intel® ATOM™ pooled compute drawer 1410, a pooled storage drawer 1412, a pooled memory drawer 1414, and a pooled I/O drawer 1416. Each of the pooled system drawers is connected to ToR switch 1404 via a high-speed link 1418, such as an Ethernet link or a Silicon Photonics (SiPh) optical link.

Multiple of the computing racks 1402 may be interconnected via their ToR switches 1404 (e.g., to a pod-level switch or data center switch), as illustrated by connections to a network 1420. In some embodiments, groups of computing racks 1402 are managed as separate pods via pod manager(s) 1406. In some embodiments, a single pod manager is used to manage all of the racks in the pod. Alternatively, distributed pod managers may be used for pod management operations.

Environment 1400 further includes a management interface 1422 that is used to manage various aspects of the environment. This includes managing rack configuration, with corresponding parameters stored as rack configuration data 1424. Environment 1400 can be used for computing racks.

Embodiments herein may be implemented in various types of computing and networking equipment, such as switches, routers, racks, and blade servers such as those employed in a data center and/or server farm environment. The servers used in data centers and server farms comprise arrayed server configurations such as rack-based servers or blade servers. These servers are interconnected in communication via various network provisions, such as partitioning sets of servers into Local Area Networks (LANs) with appropriate switching and routing facilities between the LANs to form a private Intranet. For example, cloud hosting facilities may typically employ large data centers with a multitude of servers. A blade comprises a separate computing platform that is configured to perform server-type functions, that is, a “server on a card.” Accordingly, each blade includes components common to conventional servers, including a main printed circuit board (main board) providing internal wiring (e.g., buses) for coupling appropriate integrated circuits (ICs) and other components mounted to the board.

Various examples may be implemented using hardware elements, software elements, or a combination of both. In some examples, hardware elements may include devices, components, processors, microprocessors, circuits, circuit elements (e.g., transistors, resistors, capacitors, inductors, and so forth), integrated circuits, ASICs, PLDs, DSPs, FPGAs, memory units, logic gates, registers, semiconductor device, chips, microchips, chip sets, and so forth. In some examples, software elements may include software components, programs, applications, computer programs, application programs, system programs, machine programs, operating system software, middleware, firmware, software modules, routines, subroutines, functions, methods, procedures, software interfaces, APIs, instruction sets, computing code, computer code, code segments, computer code segments, words, values, symbols, or any combination thereof. Determining whether an example is implemented using hardware elements and/or software elements may vary in accordance with any number of factors, such as desired computational rate, power levels, heat tolerances, processing cycle budget, input data rates, output data rates, memory resources, data bus speeds and other design or performance constraints, as desired for a given implementation. It is noted that hardware, firmware and/or software elements may be collectively or individually referred to herein as “module,” or “logic.” A processor can be one or more combination of a hardware state machine, digital control logic, central processing unit, or any hardware, firmware and/or software elements.

Some examples may be implemented using or as an article of manufacture or at least one computer-readable medium. A computer-readable medium may include a non-transitory storage medium to store logic. In some examples, the non-transitory storage medium may include one or more types of computer-readable storage media capable of storing electronic data, including volatile memory or non-volatile memory, removable or non-removable memory, erasable or non-erasable memory, writeable or re-writeable memory, and so forth. In some examples, the logic may include various software elements, such as software components, programs, applications, computer programs, application programs, system programs, machine programs, operating system software, middleware, firmware, software modules, routines, subroutines, functions, methods, procedures, software interfaces, API, instruction sets, computing code, computer code, code segments, computer code segments, words, values, symbols, or any combination thereof.

According to some examples, a computer-readable medium may include a non-transitory storage medium to store or maintain instructions that when executed by a machine, computing device or system, cause the machine, computing device or system to perform methods and/or operations in accordance with the described examples. The instructions may include any suitable type of code, such as source code, compiled code, interpreted code, executable code, static code, dynamic code, and the like. The instructions may be implemented according to a predefined computer language, manner or syntax, for instructing a machine, computing device or system to perform a certain function. The instructions may be implemented using any suitable high-level, low-level, object-oriented, visual, compiled and/or interpreted programming language.

One or more aspects of at least one example may be implemented by representative instructions stored on at least one machine-readable medium which represents various logic within the processor, which when read by a machine, computing device or system causes the machine, computing device or system to fabricate logic to perform the techniques described herein. Such representations, known as “IP cores” may be stored on a tangible, machine readable medium and supplied to various customers or manufacturing facilities to load into the fabrication machines that actually make the logic or processor.

The appearances of the phrase “one example” or “an example” are not necessarily all referring to the same example or embodiment. Any aspect described herein can be combined with any other aspect or similar aspect described herein, regardless of whether the aspects are described with respect to the same figure or element. Division, omission or inclusion of block functions depicted in the accompanying figures does not infer that the hardware components, circuits, software and/or elements for implementing these functions would necessarily be divided, omitted, or included in embodiments.

Some examples may be described using the expression “coupled” and “connected” along with their derivatives. These terms are not necessarily intended as synonyms for each other. For example, descriptions using the terms “connected” and/or “coupled” may indicate that two or more elements are in direct physical or electrical contact with each other. The term “coupled,” however, may also mean that two or more elements are not in direct contact with each other, but yet still co-operate or interact with each other.

The terms “first,” “second,” and the like, herein do not denote any order, quantity, or importance, but rather are used to distinguish one element from another. The terms “a” and “an” herein do not denote a limitation of quantity, but rather denote the presence of at least one of the referenced items. The term “asserted” used herein with reference to a signal denote a state of the signal, in which the signal is active, and which can be achieved by applying any logic level either logic 0 or logic 1 to the signal. The terms “follow” or “after” can refer to immediately following or following after some other event or events. Other sequences of steps may also be performed according to alternative embodiments. Furthermore, additional steps may be added or removed depending on the particular applications. Any combination of changes can be used and one of ordinary skill in the art with the benefit of this disclosure would understand the many variations, modifications, and alternative embodiments thereof.

Disjunctive language such as the phrase “at least one of X, Y, or Z,” unless specifically stated otherwise, is otherwise understood within the context as used in general to present that an item, term, etc., may be either X, Y, or Z, or any combination thereof (e.g., X, Y, and/or Z). Thus, such disjunctive language is not generally intended to, and should not, imply that certain embodiments require at least one of X, at least one of Y, or at least one of Z to each be present. Additionally, conjunctive language such as the phrase “at least one of X, Y, and Z,” unless specifically stated otherwise, should also be understood to mean X, Y, Z, or any combination thereof, including “X, Y, and/or Z.”

Illustrative examples of the devices, systems, and methods disclosed herein are provided below. An embodiment of the devices, systems, and methods may include any one or more, and any combination of, the examples described below.

Flow diagrams as illustrated herein provide examples of sequences of various process actions. The flow diagrams can indicate operations to be executed by a software or firmware routine, as well as physical operations. In some embodiments, a flow diagram can illustrate the state of a finite state machine (FSM), which can be implemented in hardware and/or software. Although shown in a particular sequence or order, unless otherwise specified, the order of the actions can be modified. Thus, the illustrated embodiments should be understood only as an example, and the process can be performed in a different order, and some actions can be performed in parallel. Additionally, one or more actions can be omitted in various embodiments; thus, not all actions are required in every embodiment. Other process flows are possible.

Various components described herein can be a means for performing the operations or functions described. Each component described herein includes software, hardware, or a combination of these. The components can be implemented as software modules, hardware modules, special-purpose hardware (e.g., application specific hardware, application specific integrated circuits (ASICs), digital signal processors (DSPs), etc.), embedded controllers, hardwired circuitry, and so forth.

Example 1 includes a method comprising: providing a device with access to a descriptor, wherein the descriptor comprises a first format of an organization of fields and field sizes; based on the first format of the descriptor differing from a second format of descriptor associated with a second device: performing a translation of the descriptor from the first format to the second format and storing the translated descriptor in the second format for access by the second device; and based on the first format of the descriptor matching the second format of descriptor associated with the second device, storing the descriptor for access by the second device.

Example 2 includes one or more other examples, wherein the first format is associated with a driver and comprising: based on the second device providing a second descriptor of the second format: performing a translation of the second descriptor from the second format to the first format associated with the driver and storing the translated second descriptor for access by the driver.

Example 3 includes one or more other examples and includes: the second device accessing the translated descriptor; the second device modifying content of the translated descriptor to identify a work request; performing a translation of the modified translated descriptor into the first format; and storing the translated modified translated descriptor for access by a driver.

Example 4 includes one or more other examples and includes: based on a change from the second device to a third device and the third device being associated with a descriptor format that is different than the first format of the descriptor, utilizing a driver for the second device to communicate descriptors to and from the third device based on descriptor translation.

Example 5 includes one or more other examples, wherein the second device comprises one or more of: a network interface controller (NIC), infrastructure processing unit (IPU), storage controller, and/or accelerator device.

Example 6 includes one or more other examples and includes: performing an intermediate application configured with one or more virtual targets for communication of a descriptor identifier from one or more virtualized execution environments (VEEs) to one or more corresponding queues of the second device, wherein virtual targets correspond one-to-one with VEEs and the virtual targets correspond one-to-one with queues of the second device.

Example 7 includes one or more other examples, wherein the intermediate application is based on virtual data path acceleration (vDPA).

Example 8 includes one or more other examples and includes: an apparatus comprising: a descriptor format translator accessible to a driver, wherein: the driver and descriptor format translator share access to transmit and receive descriptors and based on a format of a descriptor associated with a device differing from a second format of descriptor associated with the driver, the descriptor format translator is to: perform a translation of the descriptor from the format to the second format and store the translated descriptor in the second format for access by the device.

Example 9 includes one or more other examples, wherein: the device is to access the translated descriptor; the device is to modify content of the translated descriptor to identify at least one work request; and the descriptor format translator is to translate the modified translated descriptor into the format and store the translated modified translated descriptor for access by the driver.

Example 10 includes one or more other examples, wherein: based on a format of a descriptor associated with the device matching the second format of descriptor associated with the driver, the descriptor format translator is to store the descriptor for access by the device.

Example 11 includes one or more other examples, wherein: the device comprises one or more of: a network interface controller (NIC), infrastructure processing unit (IPU), storage controller, and/or accelerator device.

Example 12 includes one or more other examples and includes: a server to execute a virtualized execution environment (VEE) to request work performance by the device or receive at least one work request from the device via the descriptor format translator.

Example 13 includes one or more other examples and includes: a non-transitory computer-readable medium comprising instructions stored thereon, that if executed by one or more processors, cause the one or more processors to: perform an intermediate application configured with one or more virtual targets for communication of a descriptor identifier from one or more virtualized execution environments (VEEs) to one or more corresponding device queues, wherein virtual targets correspond one-to-one with VEEs and the virtual targets correspond one-to-one with device queues.

Example 14 includes one or more other examples, wherein the intermediate application is consistent with virtual data path acceleration (vDPA).

Example 15 includes one or more other examples, wherein a number of device queues allocated to VEEs is based on a number of virtual targets configured in the intermediate application.

Example 16 includes one or more other examples, wherein at least one virtual target comprises a vhost target.

Example 17 includes one or more other examples and includes: configuring a maximum number of device queues in the device at device boot.

Example 18 includes one or more other examples, wherein the device comprises one or more of: a network interface controller (NIC), infrastructure processing unit (IPU), storage controller, and/or accelerator device.

Example 19 includes one or more other examples, wherein communication of a descriptor identifier from one or more VEEs to one or more corresponding device queues comprises communication using a corresponding virtual queue.

Example 20 includes one or more other examples and includes: a non-transitory computer-readable medium comprising instructions stored thereon, that if executed by one or more processors, cause the one or more processors to: permit a network interface controller (NIC) to receive packet transmit requests from a virtual function driver and indicate packet receipt to the virtual function driver, wherein a format of descriptor provided by the virtual function to the NIC is different than a communicate with associated with the NIC.

Example 21 includes one or more other examples, wherein: the virtual function driver is to communicate with the NIC using a descriptor translator, wherein: the descriptor translator to receive descriptor from the virtual function driver, the network interface controller is to interact with the descriptor translator, the virtual function driver is to support a first descriptor format, the network interface controller is to support a second descriptor format, and the first descriptor format is different than the second descriptor format.

What is claimed is:

1. A method comprising:
providing a device with access to a descriptor, wherein the descriptor comprises a first format of an organization of fields and field sizes;
based on the first format of the descriptor differing from a second format of descriptor associated with a second device:
performing a translation of the descriptor from the first format to the second format and
storing the translated descriptor in the second format for access by the second device; and
based on the first format of the descriptor matching the second format of descriptor associated with the second device, storing the descriptor for access by the second device.

2. The method of claim 1, wherein the first format is associated with a driver and comprising:
based on the second device providing a second descriptor of the second format:
performing a translation of the second descriptor from the second format to the first format associated with the driver and
storing the translated second descriptor for access by the driver.

3. The method of claim 1, comprising:
the second device accessing the translated descriptor;
the second device modifying content of the translated descriptor to identify a work request;
performing a translation of the modified translated descriptor into the first format; and
storing the translated modified translated descriptor for access by a driver.

4. The method of claim 1, comprising:
based on a change from the second device to a third device and the third device being associated with a descriptor format that is different than the first format of the descriptor, utilizing a driver for the second device to communicate descriptors to and from the third device based on descriptor translation.

5. The method of claim 1, wherein the second device comprises one or more of: a network interface controller (NIC), infrastructure processing unit (IPU), storage controller, and/or accelerator device.

6. The method of claim 1, comprising:
performing an intermediate application configured with one or more virtual targets for communication of a descriptor identifier from one or more virtualized execution environments (VEEs) to one or more corresponding queues of the second device, wherein virtual targets correspond one-to-one with VEEs and the virtual targets correspond one-to-one with queues of the second device.

7. The method of claim 6, wherein the intermediate application is based on virtual data path acceleration (vDPA).

8. An apparatus comprising:
a descriptor format translator accessible to a driver, wherein:
the driver and descriptor format translator share access to transmit and receive descriptors and
based on a format of a descriptor associated with a device differing from a second format of descriptor associated with the driver, the descriptor format translator is to:
perform a translation of the descriptor from the format to the second format and
store the translated descriptor in the second format for access by the device.

9. The apparatus of claim 8, wherein:
the device is to access the translated descriptor;
the device is to modify content of the translated descriptor to identify at least one work request; and
the descriptor format translator is to translate the modified translated descriptor into the format and store the translated modified translated descriptor for access by the driver.

10. The apparatus of claim 8, wherein:
based on a format of a descriptor associated with the device matching the second format of descriptor associated with the driver, the descriptor format translator is to store the descriptor for access by the device.

11. The apparatus of claim 8, wherein: the device comprises one or more of: a network interface controller (NIC), infrastructure processing unit (IPU), storage controller, and/or accelerator device.

12. The apparatus of claim 8, comprising:
a server to execute a virtualized execution environment (VEE) to request work performance by the device or receive at least one work request from the device via the descriptor format translator.

13. A non-transitory computer-readable medium comprising instructions stored thereon, that if executed by one or more processors, cause the one or more processors to:
perform an intermediate application configured with one or more virtual targets for communication of a descriptor identifier from one or more virtualized execution environments (VEEs) to one or more corresponding device queues, wherein virtual targets correspond one-to-one with VEEs and the virtual targets correspond one-to-one with device queues.

14. The computer-readable medium of claim 13, wherein the intermediate application is consistent with virtual data path acceleration (vDPA).

15. The computer-readable medium of claim 13, wherein a number of device queues allocated to VEEs is based on a number of virtual targets configured in the intermediate application.

16. The computer-readable medium of claim 13, wherein at least one virtual target comprises a vhost target.

17. The computer-readable medium of claim 13, comprising:
configuring a maximum number of device queues in the device at device boot.

18. The computer-readable medium of claim 13, wherein the device comprises one or more of: a network interface controller (NIC), infrastructure processing unit (IPU), storage controller, and/or accelerator device.

19. The computer-readable medium of claim 13, wherein communication of a descriptor identifier from one or more VEEs to one or more corresponding device queues comprises communication using a corresponding virtual queue.

20. A non-transitory computer-readable medium comprising instructions stored thereon, that if executed by one or more processors, cause the one or more processors to:
permit a network interface controller (NIC) to receive packet transmit requests from a virtual function driver and indicate packet receipt to the virtual function driver, wherein a format of descriptor provided by the virtual function to the NIC is different than a communicate with associated with the NIC.

21. The computer-readable medium of claim 20, wherein:
the virtual function driver is to communicate with the NIC using a descriptor translator, wherein:
the descriptor translator to receive descriptor from the virtual function driver,
the network interface controller is to interact with the descriptor translator,
the virtual function driver is to support a first descriptor format,
the network interface controller is to support a second descriptor format, and
the first descriptor format is different than the second descriptor format.
